(19) United States
(12) Patent Application Publication
(10) Pub. No.: US 2002/0194082 A1
(43) Pub. Date: Dec. 19, 2002

(54) Bulletin board managing and charging system

(76) Inventor: Kuniyoshi Maruyama, Gunma-ken (JP)

Correspondence Address: KLAUBER & JACKSON, 411 HACKENSACK AVENUE, HACKENSACK, NJ, 07601

(21) Appl. No.: 10/080,822

(22) Filed: Feb. 22, 2002

(30) Foreign Application Priority Data
Jun. 19, 2001 (JP) P2001-234198

(51) Int. Cl. G06F 17/60

(52) U.S. Cl. 705/26

(57) ABSTRACT

On a bulletin board on the Internet, if a visitor applies for a mail transmission and a gift delivery to a posted person or to a posted message, then a confirmation is made by a storage unit that the receiver of the gift is the same receiver of the mail; a confirmation is made by a payment processing unit that a payment for the gift is completed; and a mail address of the posted person or of the posted message is notified by the storage unit to the visitor, who has completed the gift, so as to allow the visitor to send a mail to the posted person.

### FIELD OF THE INVENTION

The present invention relates to an E-mail system, an E-mail managing device and a network charging method which control and manage E-mail transmissions and receptions on the Internet by using terminal units such as personal computers and cellular phones.

### BACKGROUND OF THE INVENTION

At present, bulletin boards where users can access on the Internet and can send and receive messages by using personal computers and cellular phones are available free of charge to the users or on payment made by the users to the site managers of bulletin boards as dues and fees. In a case of article sales on the Internet, where a customer can purchase a gift, a transaction is completed when the customer makes a payment directly to the site manager or salesperson and enters one's name and the receiver's address in a form to initiate the shipment of the gift.

At present, such a bulletin board faces a large magnitude of imbalance between the numbers of accesses made by visitors and by persons who are posting messages, or between the numbers of E-mail transmissions and receptions. Particularly in so-called “encounter sites”, there is an extreme difference between the numbers of messages posted by men and by women, or between the numbers of E-mail transmissions and receptions made by men and by women.

In addition, the number of mail transmissions per a visitor in such a bulletin board is excessively large. The reasons are that a plurality of messages are easily produced by copy and paste functions available on a computer, and that sending messages in plurality does not directly cost the sender very much.

Furthermore, in the above mentioned case of buying a gift on the Internet, of course, the gift purchased cannot be sent if the receiver's address is not known.

### SUMMARY OF THE INVENTION

It is an object of the present invention to provide a system which restrains the number of mail transmissions by a visitor to a large number of posted persons on a bulletin board on the Internet.

It is also an object of the present invention to provide a system which enables a visitor to send a gift to a posted person even though the visitor is not informed of an address of the posted person.

According to the present invention, a system for a bulletin board on the Internet, where a third person whose address is not open to the public can post a message, is arranged to control mail transmissions to this posted person as follows. In this system, a visitor, who is browsing on the bulletin board, applies for a mail transmission and a gift delivery to one of the posted persons. When, the system receives this application, the system confirms that the gift is for a posted person and that the mail is also for the same posted person. After this confirmation, the system then confirms by payment processing means that a payment for the gift is completed by the visitor and notifies a mail address of the posted person by a storage unit to the visitor who has completed the gift to the posted person, so as to allow the visitor to send a mail to the posted person.

In this case, the visitor is allowed to send a message to the posted person only after he has made a gift to the posted person.

By applying the present invention, a revenue from the operation of the bulletin board is made indirectly from the sales of goods as gifts, which are sent and received between the senders and receivers of the mails handled on the bulletin board, instead of payments made directly from the users to the site manager. This way of operating a bulletin board has a great potential to create new businesses. In addition, persons who are posting messages on the bulletin board will be more serious than ever, in expectation of receiving gifts. Therefore, this condition will certainly increase the number of messages posted on the bulletin board. On the other hand, in the visitors' point of view, they will be more serious in choosing partners for mail exchange and less hesitant to participate in posting messages because they make gifts to their partners, instead of making payments to the site manager. This condition will certainly result in a reduction in the number of mail transmissions per one person and will also restrain troublesome messages, which may be otherwise sent to posted persons.

In this way, the number of messages posted on the bulletin board can be increased to bring a balance between the numbers of men and women participating and also a balance between the numbers of mail transmissions and receptions. Furthermore, the results to be achieved by the system are adjustable by changing the gift items provided and their prices, etc.

According to another feature of the present invention, a system for a bulletin board where only a site manager posts messages or a site manager controls the message posting, is arranged to manage mail transmissions to posted persons, as follows. In this system, a visitor, who is browsing on the bulletin board, applies for a mail transmission and a gift delivery to one of the posted messages. When, the system receives this application, the system confirms that the gift is for a posted message and that the mail is also for the same posted message. After this confirmation, the system then confirms by payment processing means that a payment for the gift is completed by the visitor, and notifies a mail address of the posted message to the visitor who has completed the gift to the posted message, so as to allow the visitor to send a mail.

In this case, also, the visitor is allowed to send a message to a posted subject only after he has made a gift to the posted subject.

As described, this system is a bulletin board managing and charging system for a bulletin board where a site manager or someone who is engaged in the operation of the bulletin board posts messages on behalf of clients. For example, a bulletin board of a show business company may list the places, dates, etc. of public performances of performers, for example, in the following format: “A performance of XX is held by XX company at the XX theater at XX o'clock on the XXth day of XX. In this case, the posted massages describe the names of performers, the names of theaters, and the dates of the performances held by the performers at these theaters. A visitor makes a gift to one of the messages and sends a mail. The receiver of the gift and the mail is the performer who is listed with that particular message. Flowers, which are useful in decorating the stage, may be sent as a gift, but other items which are not related directly to the performance may be also sent as a gift. Furthermore, the mail received may be printed and posted at the theater to cheer the performer, as a message from a fan.

In this way, the present invention can create a new business that acts as go-between in making gifts to performers, and can bring a new revenue in addition to that earned from the performances.

This feature of the present invention can be applied to many situations. For example, a bulletin board may introduce politicians, hostesses of eating houses, publication parties or award-winning parties of writers, etc.

As a future funeral business, a bulletin board may carry a list of deceased persons and act as go-between. In this case, items of offering are used as the above described gifts while condolences are sent in mail transmissions. It is an advantage of the bulletin board that this business can receive orders from all over the world because it is on the Internet.

As described above, a system according to the present invention has a wide range of applications.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only and thus are not limitative of the present invention and wherein:

FIG. 1 is a block diagram which shows the whole construction of a system according to the present invention.

FIG. 2 is a flow chart that shows the steps of the system followed by a visitor.

### DESCRIPTION OF THE PREFERRED EMBODIMENTS

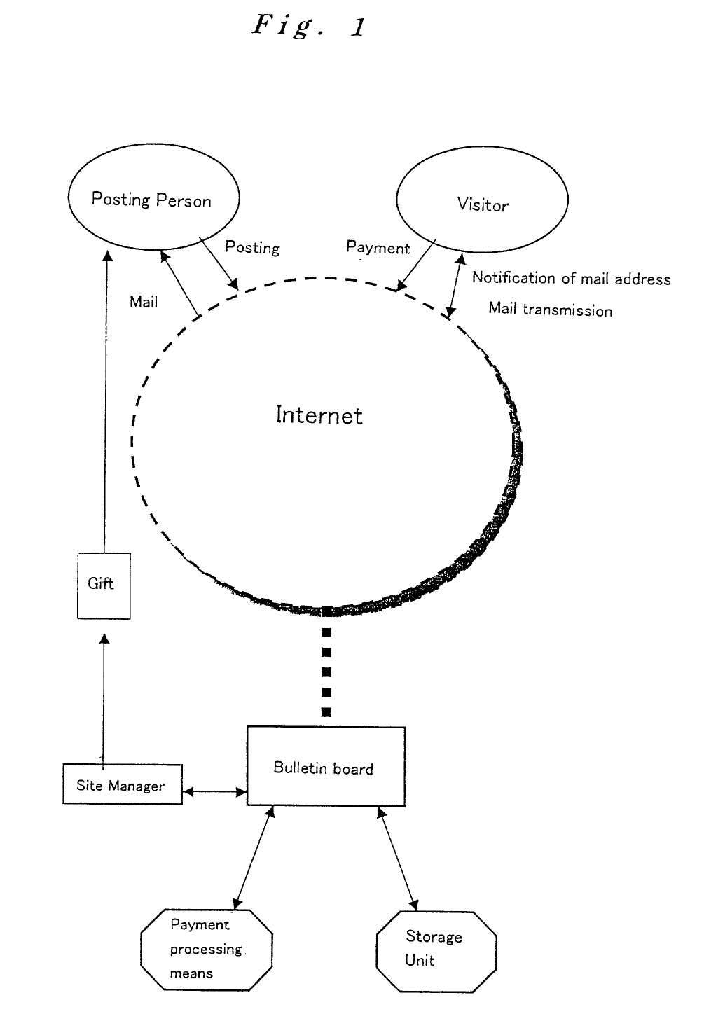

FIG. 1 shows the relations of elements in a system for bulletin board according to the present invention. This system includes a payment processing function. A visitor first connects to the Internet and accesses to the system on the Internet. While the visitor is reading the bulletin board, if the visitor wishes to send a reply to a particular message, i.e., to a person who has written and posted that particular message, which is interesting to the visitor (hereinafter, such a message is referred to as “posted message”, and such a person is referred to as “posted person”), the visitor applies for a mail transmission and orders a gift. In response, the bulletin board (server) confirms that the mail address to which the visitor wishes to send a message agrees with the address of the receiver of the gift, i.e., the posted person.

After the confirmation, the system asks the visitor to make a payment for the transaction. If the visitor completes the payment, then the mail address of the posted person is sent from the storage unit of the system to the visitor. Alternatively, this mail address may be a temporary address. After the visitor receives this address, the visitor can send a message to the posted person any time.

It is the responsibility of the site manager that the gift be delivered to the posted person, promptly. However, as the mail transmission and the physical distribution of the gift are not in synchronization, there is a time difference between the reception of the massage and the delivery of the gift.

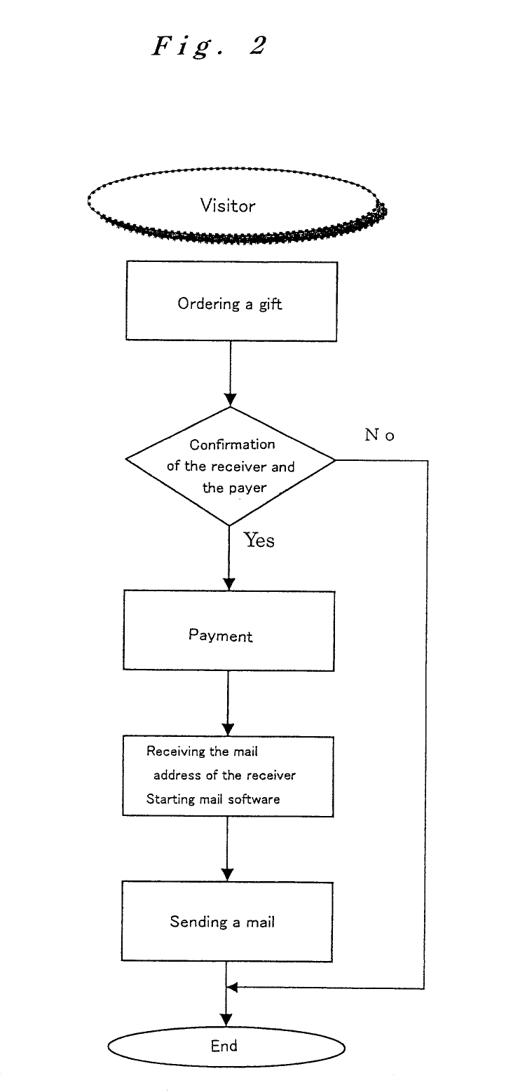

FIG. 2 shows the steps of the system followed by the visitor to achieve the above described mail transmission. At first, the visitor orders a gift for the posted person or posted message as a first step. In response to this order, the system asks the visitor to confirm the receiver and the payer and to consent to the payment. The system then confirms the completion of the payment by the visitor as a second step. After the confirmation of the payment, the mail address of the posted person or the posted message is notified from the storage unit to the visitor as a third step. In this instance, for example, mailing software is started to send the notification in a predetermined form.

The system according to the present invention performs these steps. Thereafter, the visitor sends a message at his or her convenience while the gift is delivered through a presently available distribution system.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

Related Applications

This application claims the priority of Japanese Patent Application No.2001-234198 filed on Jun. 19, 2001, which is incorporated herein by reference.

What is claimed is:

1. A bulletin board managing and charging system for a bulletin board on an internet, where a third person whose address is not open to public can post a message;
wherein:
upon receiving an application by a visitor for a mail transmission and a gift delivery to a posted person, said system performs a step to confirm the receiver of said gift and said mail by using a storage unit, a step to confirm a payment completion for said gift to said posted person by using payment processing means, and a step to notify a mail address of said posted person by using said storage unit, so as to allow said visitor, who has completed said gift to said posted person, to send a mail to said posted person.

2. The system set forth in claim 1, wherein said system performs, after the confirmation of said payment completion, a step to deliver said gift to said posted person by using physical distribution means.

3. A bulletin board managing and charging system for a bulletin board on an internet, where a manager posts a message;
wherein:
upon receiving an application by a visitor for a mail transmission and a gift delivery to a posted message, said system performs a step to confirm said message to which said gift and said mail are directed, by using a storage unit, a step to confirm a payment completion for said gift to said posted message by using payment processing means, and a step to notify a mail address of said posted message by using said storage unit, so as to allow said visitor, who has completed said gift to said posted message, to send a mail to said posted message.

4. The system set forth in claim 3, wherein said system performs, after the confirmation of said payment completion, a step to deliver said gift to a person who corresponds to said posted message by using physical distribution means.
